(19) United States
(12) Patent Application Publication
(10) Pub. No.: US 2004/0197107 A1
(43) Pub. Date: Oct. 7, 2004

(54) Method for the ocdma encoding of optical signals

(76) Inventor: Habib Fathallah, Quebec (CA)

Correspondence Address: Garabed Nahabedian, 55 St Jacques, Montreal, QC, H2Y 3X2, CA

(21) Appl. No.: 10/476,244

(22) PCT Filed: May 1, 2002
(86) PCT No.: PCT/CA02/00649

Related U.S. Application Data
(60) Provisional application No. 60/287,373, filed on May 1, 2001.

(51) Int. Cl. H04B 10/04

(52) U.S. Cl. 398/190

(57) ABSTRACT

A method for encoding optical signals using OCDMA is provided. A dense frequency grid Gm is defined from a base frequency grid G0 having a plurality of frequencies evenly spaced by a frequency spacing Bc, merged with a plurality of shifted frequency grids Gs each shifted with respect to the base frequency G0 by a frequency shift df smaller than the frequency spacing Bc. The optical signal are encoded with OCDMA codes each using a plurality of optical pulses each having a frequency selected from the dense frequency grid Gm, the frequencies of the optical pulses of a given OCDMA code being distanced from each other by at least the frequency spacing Bc.

### FIELD OF THE INVENTION

The present invention relates to the field of optical communications and more particularly concerns a method and system for the OCDMA encoding of optical signals utilising a whole spectral waveband.

### BACKGROUND OF THE INVENTION

In spectral OCDMA techniques, especially the positive ones such as FFH-OCDMA and FE-OCDMA, the power or energy contained in a data or chip pulse is key in several signal processing operations.

In non-OCDMA techniques, the energy represents the logic level ONE, no-energy represents the logic level ZERO. In addition, the quantity of energy contained in a bit defines the performance, i.e., the bit error rate.

In OCDMA however, the energy serves for threshold comparison, interference estimation, codes selection and bit value decision etc. In addition, the power exists in different forms, chips, bits, noise etc. Unlike non-OCDMA systems, the performance of OCDMA systems however is a complex function of different parameters, as it depends on power, codes, interference, traffic etc. Hence, the time and frequency shape of the waveform used for bit and chip pulses has a direct impact on the system performance. This is due to the effect that power distribution through the time and frequency axes is not uniform.

Referring to FIG. 1 (PRIOR ART), there is shown a typical OFFH-CDMA system according to prior art. In such systems, frequency slots are usually made using passive filtering of an incoherent broadband source. This approach is advantageous in that it does not require stringent frequency control loops, and it facilitates a decrease in the spacing between frequencies, therefore increasing their density. This, however, does not completely remove the need for a spacing between frequencies, which results in a loss of bandwidth. As described in FIG. 1, using a non-coherent broadband source followed by an external intensity modulator driven by an electric ON/OFF data signal with low duty-cycle RZ waveforms, the optical broadband pulses carrying the information data are generated. In the illustrated example, the first mirror of the series reflects the sub-band centred at f3, the second in the line reflects f1 and so on until f9. The time delay between the reflected pulses is strictly determined by the physical separation distance Lc, which determines the chip duration Tc.

Since the pioneering work of Zaccarin and Kavehrad, incoherent frequency encoded-CDMA (FE-CDMA) attracted much attention. As shown in FIG. 2 (PRIOR ART), an amplitude mask based 4-F diagram transmits a subset of frequencies from an incoherent source, e.g., a light-emitting diode (LED) or amplified spontaneous emission (ASE) source. Since the source is incoherent, only unipolar codes are used, seriously reducing the network capacity in terms of number of users. At the receiver, the received signal is split into two 4-F diagrams, the first being configured for the desired code (branch D) and the second for its complement. When Hadamard or cyclic shifts of an m-sequence codes are used, this clever configuration can eliminate interfering signals, assuming ideal components are used. Some limitations to this approach have been studied, including interferometric noise and the non-uniformity of the source spectrum, gratings and mask diffraction, misalignment, etc.

Different architectures have been proposed to implement FE-CDMA encoding/decoding; all are based on optical filters such as array waveguide gratings (AWG), multiple Bragg gratings (MBG) and acoustic-optic tuneable filters.

The development of the codes in FFH-OCDMA and FE-OCDMA as well always assumes squared waveforms in both, frequency and time axis. However, this is almost never realistic. For example, using Bragg gratings to shape the chip pulses in FFH-OCDMA is dictated by the gratings response, which is often approximated by Gaussian shape. This feature is generally considered a drawback of the system, and complex gratings have been developed for making the resulting pulses more square-shaped.

### SUMMARY OF THE INVENTION

It is an object of the present invention to provide an improved method for encoding optical signals using OCDMA codes.

In accordance with a first aspect of the invention, there is provided a method for encoding optical signals for transmission through an optical network, this method comprising the steps of:

a) defining a dense frequency grid Gm comprising a base frequency grid G0 having a plurality of frequencies within a spectral waveband evenly spaced by a frequency spacing Bc, said dense frequency grid further comprising a plurality of shifted frequency grids Gs each shifted with respect to the base frequency G0 by a frequency shift df smaller than the frequency spacing Bc;

b) encoding each optical signal with an OCDMA code, said OCDMA code using a plurality of optical pulses each having a frequency selected from the dense frequency grid Gm, the frequencies of the optical pulses of a given OCDMA code being distanced from each other by at least the frequency spacing Bc.

In accordance with a second aspect of the present invention, there is also provided a method for encoding optical signals for transmission through an optical network, said method comprising the steps of:

a) defining a dense frequency grid Gm comprising a base frequency grid G0 having a plurality of frequencies within a spectral waveband evenly spaced by a frequency spacing Bc, said dense frequency grid further comprising a plurality of shifted frequency grids Gs each shifted with respect to the base frequency G0 by a frequency shift df smaller than the frequency spacing Bc;

b) defining a dense time grid G′m comprising a base time grid G′0 having a plurality of time values evenly spaced by a time interval Tc, said dense time grid G′m further comprising a plurality of shifted time grids G's each shifted with respect to the base time G′0 by a time shift dt smaller than the time interval Tc;

c) encoding each optical signal with an OCDMA code, said OCDMA code using a plurality of optical pulses each having a frequency selected from the dense frequency grid Gm, the frequencies of the optical pulses of a given OCDMA code being distanced from each other by at least the frequency spacing Bc, each of said optical pulses being delayed by a time value selected from the dense time grid G′m, consecutive optical pulses being delayed with respect to each other by at least the time interval Tc.

Other features and advantages of the present invention will be better understood upon reading of preferred embodiments thereof with reference to the appended drawings.

### BRIEF DESCRIPTION OF THE DRAWINGS

FIG. 1 (PRIOR ART) shows a typical FFH-OCDMA encoding device according to prior art.

FIG. 2 (PRIOR ART) shows a FE-OCDMA system according to prior art.

FIG. 3 illustrates a dense frequency grid Gm according to a preferred embodiment of the present invention.

FIG. 4 illustrates the combination of a dense frequency grid Gm and a dense time grid G′m according to another embodiment of the invention.

FIG. 5 illustrates chip pulses having frequencies respectively in grid G0 (top graph), grids G0 and G1 (middle graph), and grids G0, G1 and G2 (bottom graph).

FIG. 6 illustrates respectively the power distribution (top) and time distribution (bottom) as a function of frequency for the superposition of three FFH-OCDMA codes.

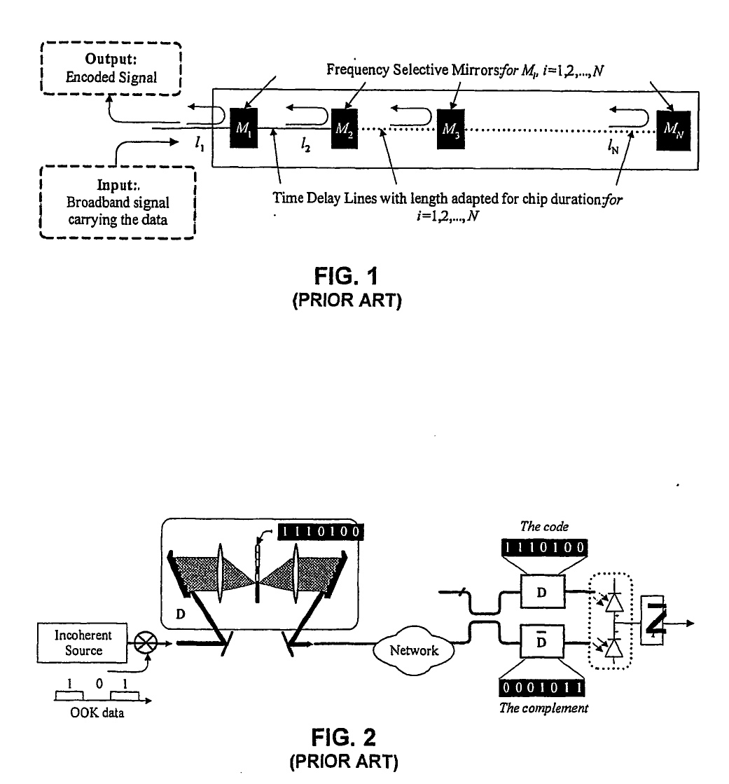

### DESCRIPTION OF PREFERRED EMBODIMENTS OF THE INVENTION

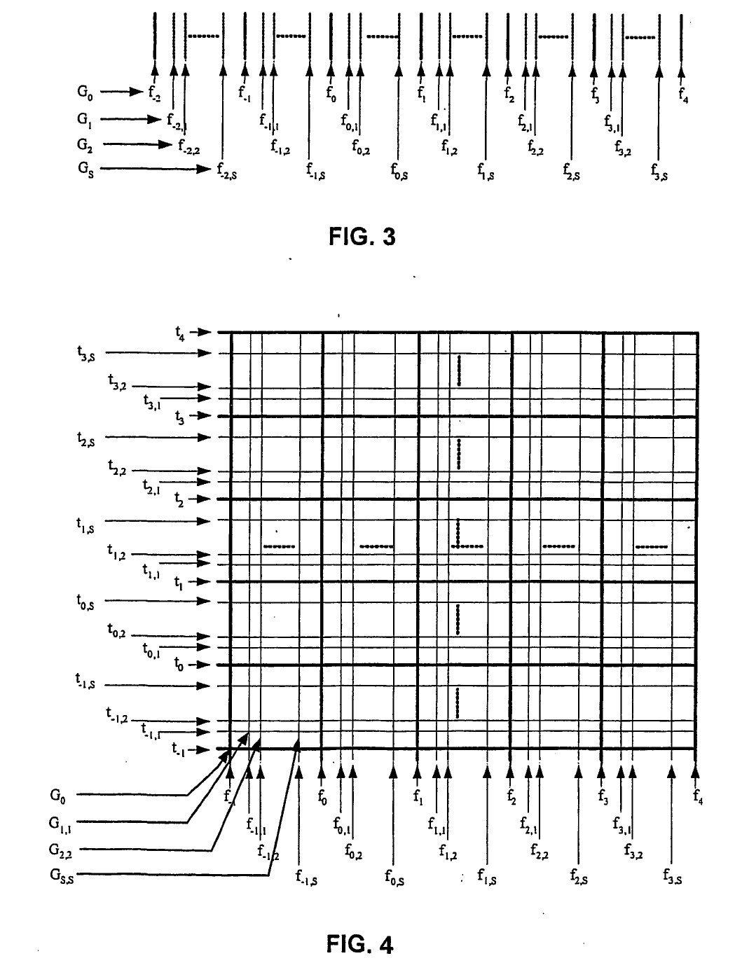

In accordance with the present invention, OCDMA encoding of optical signals is done using a dense frequency grid Gm. An example of such a grid is shown in FIG. 3. The frequency grid is obtained by first defining a base frequency grid G0, holding a plurality of evenly spaced frequency values f1, f2, f3, . . . fm. The frequency spacing between consecutive frequency values within the Grid G0 is designated Bc. A plurality of shifted frequency grids Gs are then obtained by shifting G0 by a frequency shift df, where df<Bc. The merging of the base frequency grid G0 and all the shifted grids Gs defines the dense frequency grid Gm. It should be noted that the various shifted grids Gs are not necessarily uniformly shifted with respect to the base frequency grid G0, and that therefore the dense frequency grid Gm could be non-uniform.

Advantageously, the frequency spacing Bc is selected to be equal or larger than the minimum frequency distance between two optical pulses generated by a given encoding system, that equal or larger than the chip spacing of the system. Therefore, two optical pulses having consecutive frequencies of the grid G0 (or therefore of any grid Gs) would not overlap.

The Gm is used to map the codes in FE- or FFH-OCDMA system in the following manner. Each code uses a plurality of optical pulses having a frequency selected from the grid Gm. However, for a given code, the minimal separation between two frequencies used is set to Bc. There is therefore no overlap between two pulses of a same code. Overlap between pulses of different codes is considered as interference and therefore processed accordingly.

The frequency shifts df between the different shifted grids Gs and the base frequency grid G0 are preferably determined by taking into account the practical shape of the optical pulses produced by an OCDMA system. As explained above, such pulse do not appear has square waves but usually take the form approximating a Gaussian or Lorentzian function, or half of a period of a sine function. The present invention therefore suggests to use the real shape of the pulses in order to determine the optimum frequency shifts. Cross-correlation calculation should be done for the codes in order to classify them and estimate the interference effect with the sub-chip overlap between codes. Since the effective spacing between the Gm grid frequencies is a number of times shorter that the chip spacing, the spectrum appears fully (or continuously) used by the system, all spacing loss is avoided.

Advantageously, the present invention allows to fully exploit the spectrum bandwidth used, and theoretically removes all spectrum spacing between various frequencies. The overlap, or interference between codes will take place in partial sub-bands rather than in complete sub-bands as with prior art. This increases the transparency between codes and the capacity of the system.

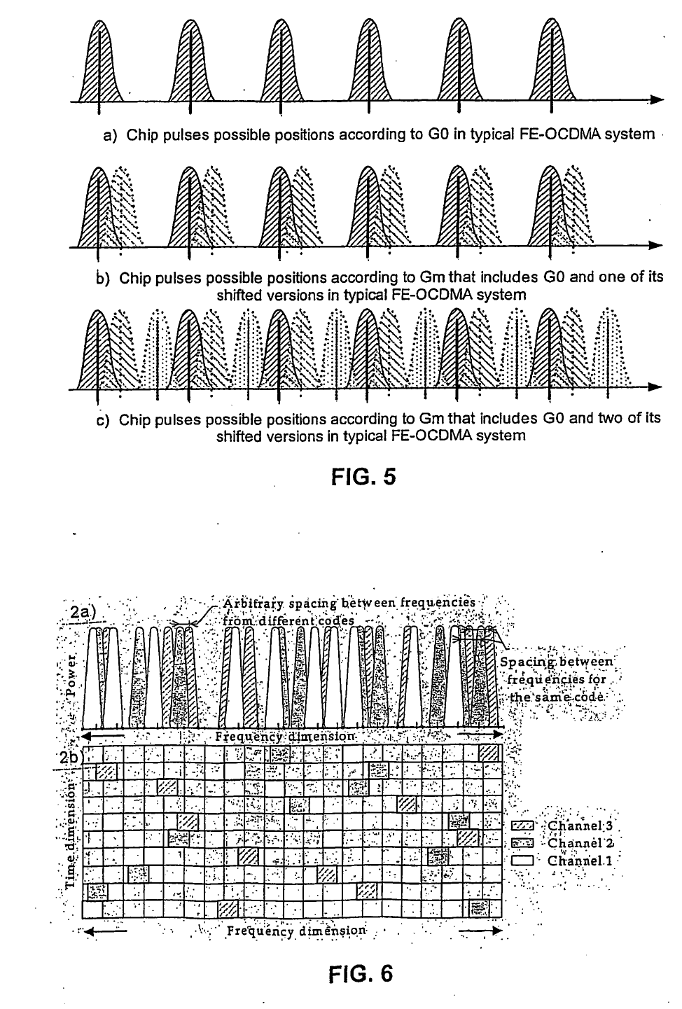

In FE-OCDMA, the existence of the uniform frequency grid G0, that specifies the mapping of the frequency axis with a uniform spacing between chips'frequencies. Introducing intermediate frequency positions between the G0 frequencies, introduces an additional degree of freedom in the encoding, hence increasing the statistical number of channels that could share the same resource. Referring to FIG. 5, there is shown an example of the position of the chip pulses for a base frequency grid G0 and two shifted frequency grids G1 and G2. As can be seen, the overlap between different pulses provides more uniformity in the distribution of the power, conceptually allows the addition of more codes and more bandwidth throughput.

Referring to FIG. 4, there is shown another embodiment of the present invention for use in FFH-CDMA encoding, where in addition to the dense frequency grid Gm, A dense time grid G′m is also provided. Similarly to the frequency grid Gm, the dense time grid G′m is based on a base time grid G′0 having a plurality of time values evenly spaced by a time interval Tc, and a plurality of shifted time grids G's each shifted with respect to the base time G′0 by. a time shift dt smaller than the time interval Tc. In this case, each OCDM code includes pulses having frequencies selected from the dense frequency grid Gm, and delays selected from the dense time grid G′m. A minimum frequency spacing of Bc and time interval of Tc between the pulses of a same code should be respected.

Referring to FIG. 6, there is illustrated a preferred embodiment of the invention. In this embodiment, the frequencies of the pulses of a given OCDMA code may be selected from a single grid Gs (or from G0). Such an embodiment is slightly more restrictive but has the advantage of preventing the superposition of pulses from different codes. In the top graph of FIG. 6, a hypothetical profile is assumed for the power spectrum density in the frequency axis. This shows the superposed frequency slices for three arbitrary users. It is clear that the frequencies belonging to the same code are constrained to be spaced with a multiple of Bc, however this constraint is not effective among frequencies from different codes. The present system therefore provides an additional degree of freedom over traditional OFFH-CDMA based network. It may therefore be exploited in order to ameliorate transparency between codes and increase the overall network capacity. The bottom graph of FIG. 6 shows the superposition of the three frequency hopping patterns corresponding to three codes'spectrums of The above graph. When a high number of connections (codes) are simultaneously active, the signal in the fiber will be seen in the frequency axis as a continuum spectrum. The removal of the frequency spacing requirement means that the proposed OFFH-CDMA enables the use of the full-spectrum in the network. It should be noted that only some FFH codes are suitable for the proposed system. FFH-codes that have been developed to mitigate the Doppler Effect in wireless FFH-CDMA system are considered an interesting choice.

In summary, the present invention provides a method of optimising the spectral efficiency of a general case of wavelength based optical code division multiple access (OCDMA) network. This applies to all variants of optical fast frequency hopping (FFH) and frequency encoding (FE) techniques. In FE-OCDMA, a frequency grid is assumed to maintain a specific uniform spacing between frequency components. In FFH-CDMA, a frequency and a time (matrix) grid is similarly defined and assumed to be respected in assigning the FFH codes. The invention proposes to exploit the original grid (G0), in order to derive a number of M shifted versions Gs, s=1 to M), in the frequency axis for FE-OCDMA, and in both axis for FFH-OCDMA. In the resource assignment or code development process, we consider the merge of the original grid within its shifted versions as a new grid (Gm). Since the shifted versions are not necessarily uniformly shifted, the new grid Gm could be non-uniform.

Advantageously, the preferred embodiment of the present invention take benefit from the practical shape properties of the signal waveforms that are generally non-uniform through the spectral and/or time axis. Inspired from that generally un-appreciated reality, the invention proposes to overcome this problem through the generation of the shifted copies of the original resource grid. The real shape of the pulses could help determining the optimum frequency shifts for FE-OCDMA (alternatively time x frequency for FFH-OCDMA).

One preferred embodiment applies the invention for FFH-OCDMA and explains the spectral efficiency. This efficiency could be represented by an increase of number of users and or increase of bandwidth trough a given resource. Another preferred embodiment applies the invention for frequency encoded OCDMA.

Depending on the network architecture and constraints, the invention could be applied on an entire fiber optic band such as, C, L and S, or a specific waveband.

Of course, numerous modifications could be made to the embodiments above without departing from the scope of the invention as defined in the appended claims.

1. A method for encoding optical signals for transmission through an optical network, said method comprising the steps of:
a) defining a dense frequency grid Gm comprising a base frequency grid G0 having a plurality of frequencies within a spectral waveband evenly spaced by a frequency spacing Bc, said dense frequency grid further comprising a plurality of shifted frequency grids Gs each shifted with respect to the base frequency G0 by a frequency shift df smaller than the frequency spacing Bc;
b) encoding each optical signal with an OCDMA code, said OCDMA code using a plurality of optical pulses each having a frequency selected from the dense frequency grid Gm, the frequencies of the optical pulses of a given OCDMA code being distanced from each other by at least the frequency spacing Bc.

2. A method according to claim 1, wherein in step a) the frequency shift df of each shift frequency grid Gs is selected so as to allow a differentiation of optical pulses having different frequencies within the dense frequency grid Gm taking into account a predetermined shape of said optical pulses.

3. The method according to claim 2, wherein, in step a), said predetermined shape is defined by a function selected from the group consisting of a gaussian and a lorentzian function and one half of a period of a sine function.

4. The method according to claim 1, wherein, in step b) said OCDMA codes are defined using a frequency encoding technique.

5. The method according to claim 1, wherein, in step b) said OCDMA codes are defined using a fast frequency hopping technique.

6. The method according to claim 1, wherein, in step b), the frequencies of a given OCDMA code are selected from a single frequency grid of the group consisting of the base frequency grid G0 and the shifted frequency grids Gs.

7. A method for encoding optical signals for transmission through an optical network, said method comprising the steps of:
a) defining a dense frequency grid Gm comprising a base frequency grid G0 having a plurality of frequencies within a spectral waveband evenly spaced by a frequency spacing Bc, said dense frequency grid further comprising a plurality of shifted frequency grids Gs each shifted with respect to the base frequency G0 by a frequency shift df smaller than the frequency spacing Bc;
b) defining a dense time grid G′m comprising a base time grid G′0 having a plurality of time values evenly spaced by a time interval Tc, said dense time grid G′m further comprising a plurality of shifted time grids G's each shifted with respect to the base time G′0 by a time shift dt smaller than the time interval Tc;
c) encoding each optical signal with an OCDMA code, said OCDMA code using a plurality of optical pulses each having a frequency selected from the dense frequency grid Gm, the frequencies of the optical pulses of a given OCDMA code being distanced from each other by at least the frequency spacing Bc, each of said optical pulses being delayed by a time value selected from the dense time grid G′m, consecutive optical pulses being delayed with respect to each other by at least the time interval Tc.

8. A method according to claim 7, wherein in step a) the frequency shift df of each shift frequency grid Gs is selected so as to allow a differentiation of optical pulses having different frequencies within the dense frequency grid Gm taking into account a predetermined shape of said optical pulses.

9. The method according to claim 8, wherein, in step a), said predetermined shape is defined by a function selected from the group consisting of a gaussian and a lorentzian function and one half of a period of a sine function.

10. The method according to claim 7, wherein, in step b) said OCDMA codes are defined using a fast frequency hopping technique.

11. The method according to claim 7, wherein, in step b), the frequencies of a given OCDMA code are selected from a single frequency grid of the group consisting of the base frequency grid G0 and the shifted frequency grids Gs.
